(19) United States
(12) Patent Application Publication
(10) Pub. No.: US 2006/0257188 A1
(43) Pub. Date: Nov. 16, 2006

(54) Check printing system

(75) Inventors: Kimberly J. Kroetsch, Fargo, ND (US); Samantha A. Britney, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/129,081

(22) Filed: May 13, 2005

(51) Int. Cl. B41J 29/38; B41J 13/00

(52) U.S. Cl. 400/76

(57) ABSTRACT

A check printing system is disclosed offering a unified check printing solution, supporting requirements for both enterprise resource management (ERM) and human resources management (HRM) checks in one seamless system. The system provides “in process” voiding and reprinting support. A user can void, reprint, and manage checks and check numbers in real-time during the check printing process, making the process more efficient and flexible. For example, a computer-readable medium includes computer-executable instructions. When the computer-readable medium is executed by a host computer, it configures the host computer to perform a check printing process. The host computer is configured to receive a set of payment objects from one or more data sources. Each of the payment objects is associated with an account object from among one or more account objects. The host computer is also configured to create a print session object associated with a respective account object from among one or more account objects, to retrieve a batch of check numbers from the respective account object, and to print a set of checks associated with the set of payment objects. Printing the set of checks includes entering values associated with the print session object and the payment objects to a plurality of data fields of each of the checks in the set, and assigning each check a check number from among the batch of check numbers. The host computer is also configured to provide an option at a user interface for confirming and closing the print session object, and to confirm and close the print session object if the option for confirming and closing the print session object is entered.

### BACKGROUND OF THE INVENTION

The present invention relates to business solutions, and in particular to a system for printing checks.

Current enterprise resource management (ERM) and human resources management (HRM) solutions typically provide separate check printing processes for printing checks for payments on invoices and other general expenses, and for printing payroll checks, respectively. Typically, the requirements for each process are different, with the HRM check printing solution sometimes requiring more functionality than the ERM check printing solution, for example.

Typical check printing solutions print checks as a batch. If one check or only some of the checks are printed incorrectly, a check printing system typically requires the user to reprint the entire batch or range of checks, and the original checks are not voided until the entire check batch is posted.

Typical check printing solutions also allow two separate users to attempt to print checks from the same source of checks at the same time. Such systems update information on a batch of checks when the batch is posted, after the checks are printed. Unfortunately, this allows a second user to retrieve a set of check data in the interim while the first user is still printing checks with those same check data, leading to duplication errors.

### SUMMARY OF THE INVENTION

The check printing system of the present invention offers a unified check printing solution, supporting requirements for both enterprise resource management (ERM) and human resources management (HRM) checks in one seamless system, in various embodiments. Embodiments of the system provide “in process” voiding and reprinting support. A user can void, reprint, and manage checks and check numbers in real-time during the check printing process, making the process more efficient and flexible, in various embodiments.

For example, one illustrative embodiment includes a computer-readable medium that includes computer-executable instructions. When the computer-readable medium is executed by a host computer, it configures the host computer to perform a check printing process. The host computer is configured to receive a set of payment objects from one or more data sources. Each of the payment objects is associated with an account object from among one or more account objects. The host computer is also configured to create a print session object associated with a respective account object from among one or more account objects, to retrieve a batch of check numbers from the respective account object, and to print a set of checks associated with the set of payment objects. Printing the set of checks includes entering values associated with the print session object and the payment objects to a plurality of data fields of each of the checks in the set, and assigning each check a check number from among the batch of check numbers. The host computer is also configured to provide an option at a user interface for confirming and closing the print session object, and to confirm and close the print session object if the option for confirming and closing the print session object is entered.

Another illustrative embodiment includes a process for printing checks, including several steps, as follows. One of the steps of the process is receiving a set of obligated payments to be made. Another step is retrieving a batch of check numbers from an account object. Another step is printing a set of checks, of which each check in a print session corresponds to one of the obligated payments, and to the account object. Printing the set of checks includes entering values to data fields of each of the checks, and assigning each of the checks a check number from among the batch of check numbers. The process also includes the step of providing a set of options at a user interface, which may include options for selecting any one or more checks from among the set of checks, an option for voiding the selected one or more checks, an option for reprinting the selected one or more checks, an option for saving the print session, and an option for confirming the print session. Other steps include voiding the selected one or more checks if the option for voiding the selected check is entered, reprinting the selected one or more checks if the option for reprinting the selected one or more checks is entered, saving the print session if the option for saving the print session is entered, and confirming the print session if the option for confirming the print session is entered.

Another illustrative embodiment includes a computing environment that includes an object model for a check printing process. The object model includes a check printing process object that constitutes the root object of the object model. The object model also includes one or more print session objects. The check printing process object and the print session objects are respectively in a parent-child relationship and a one-to-many relationship. The object model further includes an account object associated with at least one of the one or more print session objects. The object model also includes one or more check print objects. At least one of the print session objects and the check print objects are respectively in a parent-child relationship and a one-to-many relationship. The object model further includes a payment object associated with at least one of the check print objects.

Additional features and advantages of different embodiments will be understood by those of skill in the art from the illustrative embodiments as described and depicted in the description and figures herein.

### BRIEF DESCRIPTION OF THE DRAWINGS

FIG. 1 depicts a block diagram of a host computer suitable for a computer-readable medium of the present invention to be loaded onto and configured in accordance with, and for executing the instructions included in the computer-readable medium, according to one illustrative embodiment.

FIG. 2 depicts a simplified program object diagram of a configuration of a host computer in accordance with computer-executable instructions included on a computer-readable medium and executed by the host computer, according to one illustrative embodiment.

FIG. 3 depicts a flowchart representing a process according to another illustrative embodiment.

### DETAILED DESCRIPTION OF ILLUSTRATIVE EMBODIMENTS

As stated above, the check printing system of the present invention offers a unified check printing solution, supporting requirements for both enterprise resource management (ERM) and human resources management (HRM) checks in one seamless system, in various embodiments. Embodiments of the system provide “in process” voiding and reprinting support. A user can void, reprint, and manage checks and check numbers in real-time during the check printing process, making the process more efficient and flexible, in various embodiments.

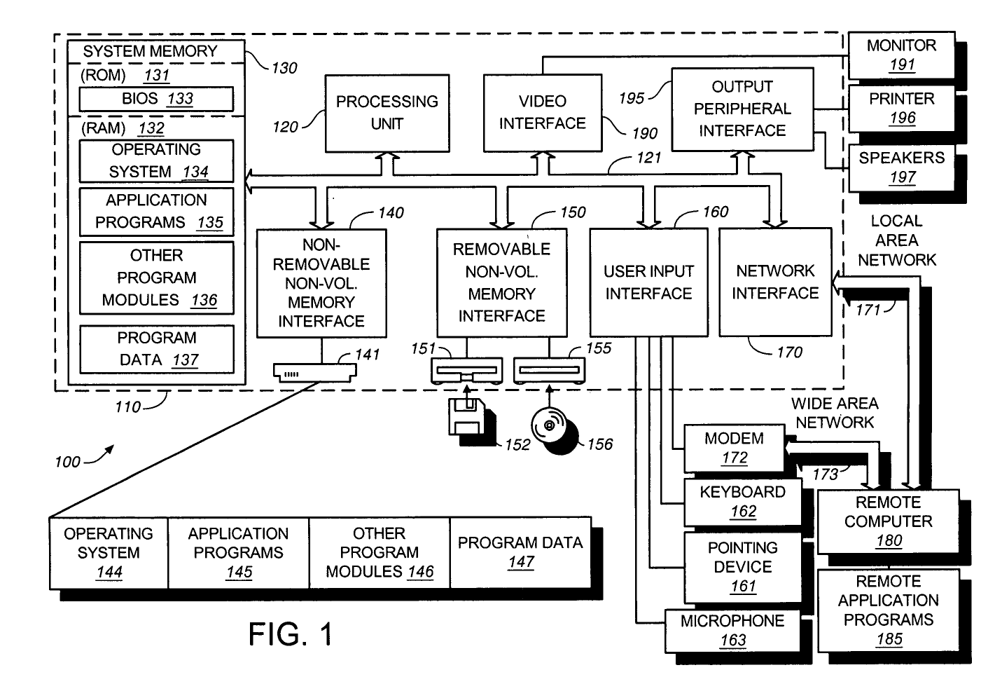

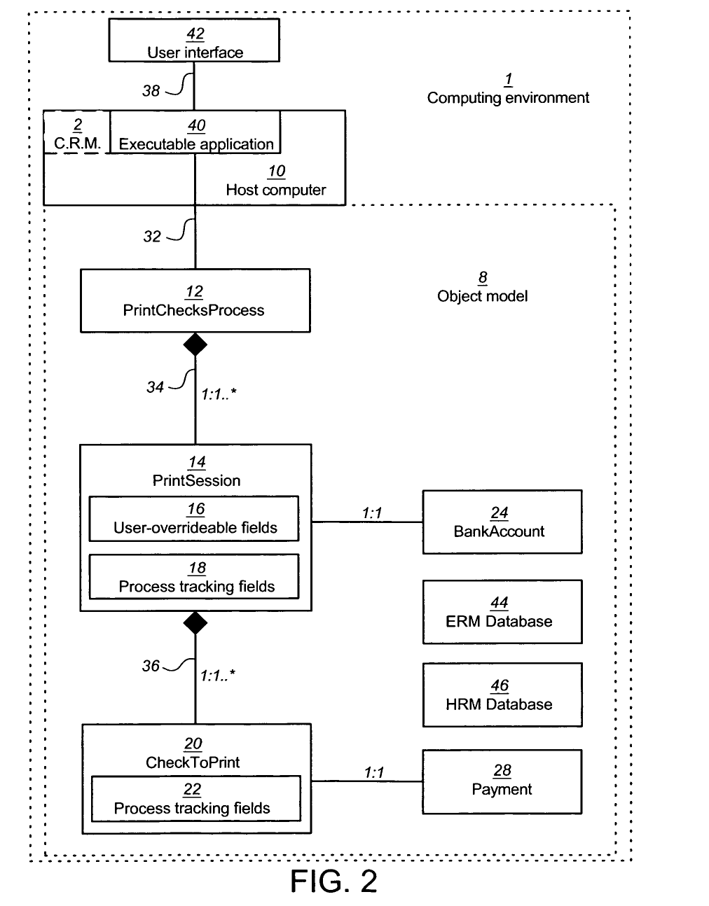

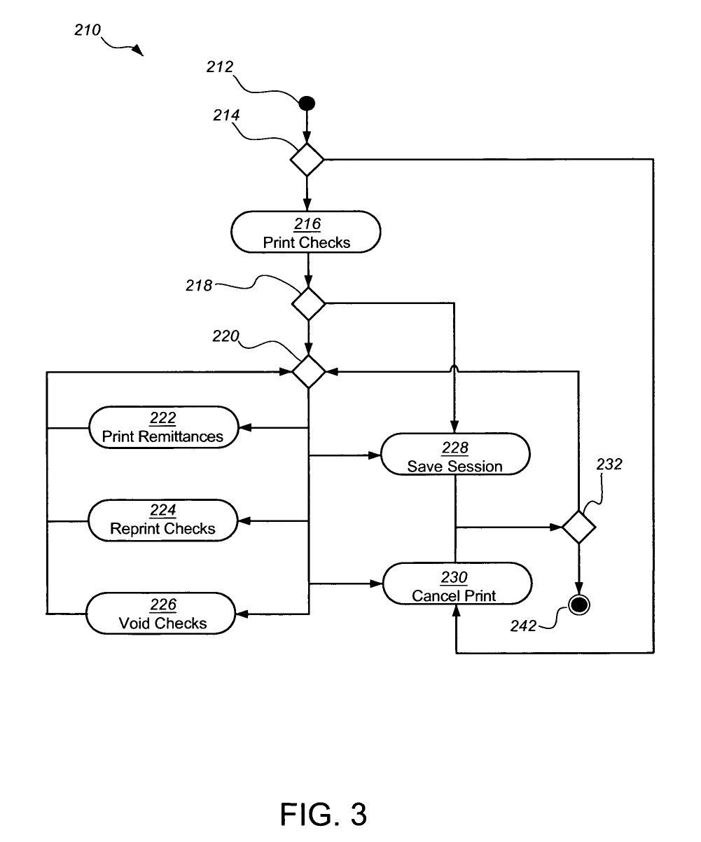

FIG. 1 depicts a fairly generalized environment in which the present invention may be incorporated in accordance with some illustrative embodiments. FIGS. 2 and 3, described in a later section, more particularly depict some of the specific aspects of some illustrative embodiments. As an illustrative example, FIG. 1 depicts a block diagram of a computing system environment 100 including host computer 110 suitable for a computer-readable medium of the present invention to be loaded onto and configured in accordance with, and for executing the instructions included in the computer-readable medium, according to one illustrative embodiment. The computing system environment 100 is one of many possible examples of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Various embodiments of the invention are operational with numerous other general purpose or special purpose computing system environments or configurations. Examples of well known computing systems, environments, and/or configurations that may be suitable for use with the invention include, but are not limited to: personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as executable program modules and files generated in the context of executable program modules, being executed by a computer. Generally, program modules may include routines, programs, objects, components, data structures, files, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

Computer 110 typically includes a variety of computer-readable media, and means for accessing such computer-readable media and executing instructions included thereon. Computer-readable media can be any available media that can be accessed by computer 110 and can include both volatile and nonvolatile media, both removable and non-removable media, and both local and remote media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 100, whether by local bus, local network, or a remote network connection such as over the Internet. Communication media typically embody computer-readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disc drive 141 that reads from or writes to non-removable, nonvolatile magnetic media, a magnetic disc drive 151 that reads from or writes to a removable, nonvolatile magnetic disc 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disc drive 141 is typically connected to the system bus 121 through a non-removable memory interface such as interface 140, and magnetic disc drive 151 and optical disc drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disc drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a handheld device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

In the present description, embodiments are described with reference to acts and symbolic representations of operations that are performed by one or more computers configured to execute such operations, unless indicated otherwise. As such, it is understood that such operations, which are at times referred to as being executed by the computer, include the manipulation by a processing unit, included in the computer, of electrical signals representing structured data. Such manipulation may transform the data or maintain it at locations in memory systems of the computer, which reconfigures or otherwise alters the operation of the computer in a manner well understood by those skilled in the relevant arts. The data structures where data is maintained are physical locations of the memory that have particular properties defined by the format of the data. Other forms of implementation encompassed within the present invention may be included in other embodiments.

As is apparent to those with skill in the relevant arts, the simplified block diagram of FIG. 2 and the flowchart of FIG. 3 are applicable to any of a wide variety of hardware systems, operating systems, and other implementation modes. The systems of the embodiments depicted in FIG. 2 and FIG. 3 may be implemented in a modular or object oriented software environment, such as, for example, the component object model (COM) developed by the assignee of the present application.

FIG. 2 depicts computing environment 1 including object model 8 and host computer 10, according to this illustrative embodiment. Computing environment 1 also includes enterprise resource management (ERM) database 44 and human resource management (HRM) database 46, both of which are associated with and accessible to object model 8, in this illustrative embodiment. User interface 42 is communicatively connected to host computer 10. Object model 8, databases 44 and 46, and user interface 42 are accessible to host computer 10, either by being included with or local to host computer 10, or on another asset with which computer 10 is communicatively connected, such as over an intranet, a local area network (LAN), a wide area network (WAN), the Internet, or some other communicative connection. User interface 42 relays output from and input to host computer 10 via data connections 38, as well understood in the art and as depicted illustratively in FIG. 1. Executable application 40, when executed by computer 10, uses object model 8 to perform a check printing process, according to one illustrative embodiment. Computer 10 is thereby configured to perform a check printing process, in this embodiment. The check printing process performed by computer 10, running executable application 40 and using object model 8, is further illustrated in FIG. 3, infra, according to one illustrative embodiment.

Computer-readable medium 2 is depicted loaded onto host computer 10, configuring host computer 10 to execute the computer-executable instructions incorporated in computer-readable medium 2. Computer-readable medium 2 includes computer-executable instructions which, when executed by host computer 10, configure host computer 10 to perform a check printing process. Computer-readable medium 2 may be removed from host computer 10 in one embodiment. However, computer-readable medium 2 retains its computer-executable instructions when it is not included in or communicatively connected to a host computer. Therefore, computer-readable medium 2 comprises the entirety of the invention, in one embodiment, while the remaining components depicted in FIG. 2 provide illustration of how computer-readable medium 2 configures a host computer. In other embodiments, host computer 10 is still loaded with executable application 40 and/or is configured to perform a process according to an embodiment of the invention, as long as instructions or data associated with the embodiment are accessible on any medium readable by host computer 10. Other embodiments may include host computer 10 or other components of computing environment 1. Host computer 10 may take any of a variety of forms, including a server, a desktop computer, a notebook computer, a handheld computer, a collection of networked computers, a computing grid, or any other computer equivalent, in different applications and different embodiments.

Object model 8 is useful for a check printing process, in this illustrative embodiment. Object model 8 includes a check printing process object 12 called PrintChecksProcess, which constitutes the root object of object model 8. Object model 8 also includes a collection of print session objects 14 called PrintSession, of which there can be one or more. PrintChecksProcess object 12 and PrintSession object 14 are, respectively, in a parent-child relationship, as well as a one-to-many relationship, as indicated by relation 34. An account object 24 called BankAccount is associated with each PrintSession object 14 in a one-to-one relationship. BankAccount object 24 is an object representation of an existing account, and accordingly includes information on the available funds, the currency in which the funds are denominated, and the available check numbers in its corresponding account, for example. The association of PrintSession object 14 and BankAccount object 24 allows each PrintSession object 14 to retrieve a batch of check numbers from its respective BankAccount object 24, for example.

Object model 8 further includes one or more check print objects 20 called CheckToPrint, of which there can be one or more for each PrintSession object 14, in this embodiment. PrintSession object 14 and CheckToPrint object 20 are, respectively, in a parent-child relationship and a one-to-many relationship, as indicated by relation 36, and as somewhat analogous to the relation 34 between PrintChecksProcess object 12 and PrintSession object 14. A payment object 28 called Payment is associated with each CheckToPrint object 20 in a one-to-one relationship. Each Payment object 28 represents an obligated payment that has been added to the object model 8. Different Payment objects 28 may be received from the ERM database 44 and/or the HRM database 46, in this embodiment. Payment objects may also be received from user interface 42, based on input entered by a user through user interface 42.

Executable application 40 uses object model 8, as indicated by the relation 32 depicted between application 40 and the PrintChecksProcess object 12, which serves as the root of object model 8. Executable application 40 and/or object model 8 may be loaded onto host computer 10 from a removable computer-readable medium such as an optical disc, a magnetic disc, or a flash card, or from a remote computer-readable medium, such as a hard drive accessed over a network such as the Internet. For executable application 40 and/or object model 8 to be loaded onto host computer 10, executable application 42 and/or object model 8 are recorded in a memory storage contained within or accessible to host computer 10, such as a hard drive of host computer 10. The hard drive or other internal memory contained within host computer 10, such as hard disc drive 141 of FIG. 1, for example, then also becomes a computer-readable medium comprising computer-executable instructions which, when executed by the host computer 10, configure host computer 10 in accordance with an embodiment of the present invention. The internal memory alone of a host computer 10 therefore may come to incorporate an embodiment of the present invention.

PrintChecksProcess 12 serves as the root of object model 8, which is used by application 40 to configure the host computer 10 to accomplish certain tasks when it is executed by host computer 10, including by using the objects of object model 8. Several references are made herein to the host computer 10 being configured to accomplish a respective task or achieve a respective condition, or even to configured host computer 10. These references incorporate the understanding that it is the computer-executable instructions of the executable application 40 and/or the object model 8 rooted in PrintChecksProcess object 12, as loaded from computer-readable medium 2, and/or as necessarily hosted on some computer-readable medium comprised in host computer 10, that has configured the host computer 10 in such a way, according to an embodiment of the present invention.

For host computer 10 to be configured so that it can accomplish a respective task, such as to perform a check printing process using PrintChecksProcess object 12, does not require that host computer 10 is actually executing that task at a particular time, or indeed has ever actually executed that task. The host computer 10 being configured to execute such a task means that it is configured such that it is able to execute that task under the right conditions and contingent on receiving instructions to execute that task, in one illustrative embodiment. The host computer 10 is therefore configured to execute such a task as soon as it has communicative access to the computer-readable instructions that make it possible for the host computer 10 to execute that task, in this embodiment. Therefore, for example, even if only an executable application comprising an installation setup program for installing executable application 40, configured to access PrintChecksProcess object 12, is stored on a computer, but not yet executed, so that executable application 40 is not installed, the computer is configured in accordance with an embodiment of the present invention, because the setup program includes computer-executable instructions comprised on a computer-readable medium which, when executed by the host computer, loads executable application 40 onto the computer, thereby configuring the host computer to perform a check printing session in accordance with an embodiment of the present invention.

In the description, actions attributed to be taken by PrintChecksProcess object 12, PrintSession object 14, or CheckToPrint object 16, are among the actions performed by host computer 10 and are attributable to host computer 10, as it is configured when it executes the computer-executable instructions comprised in computer-readable medium 2, according to various embodiments. Additionally, the many features and embodiments are described in forms that relate to what the host computer 10 is configured to do once it has executed or is executing computer-executable instructions from a computer-readable medium, and that also relate to a process or a more general means for printing checks. None of the description is limited to any one of those forms; rather, those of skill in the relevant arts will appreciate that the features and embodiments described may take the form of a computer-readable medium, a process, an object model, a means for printing checks, or other embodiment formats, with equal applicability.

When application 40 is executed by host computer 10, PrintChecksProcess object 12 is passed a set of Payment objects 28 that are to be processed. PrintChecksProcess object 12 then is enabled to create an object 14 called PrintSession, with one PrintSession object 14 corresponding to each BankAccount object 24 associated with the set of Payment objects 28. Each Payment object may be associated with a corresponding account object, for example, by including data indicating a particular account object that is to be used for printing a check associated with the particular Payment object, in one illustrative embodiment. PrintChecksProcess object 12 creates as many PrintSession objects 14 as needed for a current set of Payment objects 28, and may contain several PrintSession objects 14 at one time, as indicated by the one-to-many (1:1 . . . *) relation 34 between PrintChecksProcess object 12 and representative PrintSession object 14, which is a representative one of any number of similar objects. The PrintChecksProcess object 12 and the PrintSession object 14, in that order, are in a parent-child relationship. As a Payment object 28 is added to the PrintChecksProcess object 12, a PrintSession object 14 is created or added to depending on the BankAccount object 24 referenced by the added Payment object 28. Once the PrintSession object 14 for a particular Payment object 28 is determined, a new CheckToPrint object 20 is created and a relationship added from the CheckToPrint object 20 to the Payment object 28. Again, the logical relation 36 of one-to-many (1:1 . . . *) is depicted to indicate that PrintSession object 14 may contain any number of CheckToPrint objects 20; and the PrintSession object 14 and the CheckToPrint objects 20, in that order, are in a parent-child relationship.

The PrintSession object 14 may include any number of CheckToPrint objects 20. A set of checks may include only a single CheckToPrint object 20, for example; it is well understood that a set may comprise only a single element. The CheckToPrint objects collection 20 may also include 2, 3, a thousand, or three million checks. For example, in an embodiment used by a very large employer, host computer 10 may be configured to print a set of one million payroll checks. As another example, a large nation using another embodiment of the present invention may have host computer 10 configured to print a set of thirty million income tax refund checks in one check printing session, ten million payroll checks in another check printing session, and five million contract payments in a third check printing session. All three of these check printing sessions, or any number of check printing processes, may proceed serially or concurrently according to the configuration of host computer 10 by the PrintChecksProcess object 12, according to one embodiment. It may be advantageous to use an embodiment in which host computer 10 takes the form of a networked collection of computers for some large-scale applications.

PrintSession object 14 establishes a communicative connection with a BankAccount object. The connection is depicted here as one-to-one (1:1) to indicate that a single PrintSession object 14 uses a single BankAccount object 24, in this embodiment. Any number of additional PrintSession objects 14 may be used to connect to any number of BankAccount objects 24, one check PrintSession object to one BankAccount object, in this embodiment. In this way, computer-readable medium 2 configures host computer 10 to print checks from any number of different accounts, as represented by BankAccount objects 24. In some embodiments or applications, host computer 10 may only need to be configured to use a single BankAccount object 24 through an indefinite number of PrintSession objects 14. This might be the case when the PrintChecksProcess object 12 is used by a small business with only one checking account, and all Payment objects 28 received by PrintChecksProcess object 12 refer to the same BankAccount object 24 representing that one checking account, for example. This may be a distinction of either embodiments or applications, because PrintChecksProcess module 12 may still configure host computer 10 to be able to select from among a plurality of BankAccount objects 24 even though host computer 10 is only used to access a single BankAccount object 24 in its desired application; or an enterprise that only needs simplified functionality, such as to access only a single BankAccount object 24, may be provided with a simplified embodiment. PrintChecksProcess module 12 also includes the capability to print checks from accounts denominated in any of a variety of currencies, and to print checks in any of a variety of different languages, in various embodiments. This is especially useful for larger-scale applications, such as a large enterprise with frequent transactions in many nations.

Application 40 using PrintChecksProcess object 12 may be performed by host computer 10 according to a command entered by a user via user interface 42. Alternately, a user may use a scheduling function, included in executable application 40, in this embodiment, to create a schedule for host computer 10 to execute application 40 to access object 12 automatically at certain times. The scheduling function is configured to receive operating parameters from a user, such as a time preselected by the user to perform portions of the check printing process. When the computer, running the application 40 with the scheduling function, receives an indication that the time preselected by the user has arrived, such as with reference to a clock object, the computer automatically receives a pending set of Payment objects 28; creates a PrintSession object 14; retrieves a batch of check numbers from a respective BankAccount object 24; prints the set of checks; and provides the option at the user interface for confirming and closing the PrintSession object 14, so that the step of confirming and closing the printed checks is the only action the user needs to take.

FIG. 3 depicts a flowchart representing a process 210 according to another illustrative embodiment. The process 210 is another form or another embodiment, similar to the actions performed by the host computer 10 in the description above, as it is configured by the computer-executable instructions such as comprised in the PrintChecksProcess object 12 and the other objects in object model 8, and/or as comprised in an executable application 40 configured to use object model 8. The process 210 represents one embodiment of the process performed by executable application 40 using object model 8.

Process 210 proceeds from the operation 212 of opening a new check printing session, to decision point 214, which is simply whether to proceed to print checks, or whether to cancel out of the check printing session before printing any checks. The decision to cancel leads to the Cancel Print action 230, while the decision to proceed to print leads to the Print Checks action 216. In another illustrative embodiment, the opening of a new check printing session 212 leads directly to the Print Checks action 216. Print Checks action 216 includes receiving a set of Payment objects, retrieving a batch of check numbers from an account object, matching the check numbers to respective Payment objects, and printing a set of checks associated with the respective Payment objects, similarly to the actions performed by the host computer 10 configured by the PrintChecksProcess module 12, as described above. For example, printing the checks also includes iteratively entering values from the respective database or other data source, such as user input, to a plurality of data fields of a respective check from among the set of checks, and assigning the respective check a check number from among the batch of check numbers, which is also in accordance with the actions executed by the configured host computer 10.

The Print Checks action 216 leads to decision point 218, which is whether the check printing session is automatically scheduled, such as according to a scheduling function, in this illustrative embodiment. In an embodiment or application in which the check printing process is done automatically after a scheduled trigger, such as receiving an indication that a preselected time has arrived, the checks printed at action 216 comprise the entirety of the actions to be taken, and the decision point 218 leads directly to the Save Session action 228, and from there to decision point 232, which is whether to confirm the check printing session. In an illustrative embodiment, this is the only step requiring input from a user. The user is able to review the check printing session, and is prompted whether to confirm the session, leading to the endpoint 242 to confirm and close the session, or to open additional review options, leading to decision point 220, which offers the user many options, such as the Void Checks action 226, described below. The endpoint 242 to confirm and close the session includes returning any of the check numbers from among the batch that were not assigned to a check or voided in the process to the account object from which they were retrieved. If the decision point 218 is resolved such that the check printing session is not automatically scheduled, it also leads to decision point 220, which provides the user with many options, through a user interface.

Specifically, decision point 220 leads to the Void Checks action 226, for example, for voiding one or more selected checks as one option provided to the user. If this option is entered by the user with respect to a respective check, then that check is voided. The user may review and void several checks at once. However many checks the user voids, including perhaps none, the Void Checks action 226 leads back to the multi-option decision point 220. If all outstanding printed checks have been voided, the decision point 220 may be used to access the Cancel Print action 230, in this embodiment. In another embodiment, the Cancel Print action 230 is always available from decision point 220, and if selected will include the voiding of all outstanding printed checks. As described above, the Cancel Print action 230 leads to decision point 232 for either confirming and ending the check printing session 210 or returning to the multi-option decision point 220.

As another option offered at decision point 220 in this illustrative embodiment, the user may opt for the Save Session action 228, the same that can be reached from decision point 218 in the case of a scheduled, automatic check printing session. If the user enters the option for the Save Session action 228, the user may then proceed to decision point 232; or the user may opt to leave the check printing session at the Save Session action 228, where the check printing session can safely be held in place, with the outstanding printed checks saved for later action, until the user returns and reopens the saved check printing session and resumes the check printing session by then proceeding from the Save Session action 228.

The multi-option decision point 220 also provides the option to proceed to a Reprint Checks action 224, for reprinting one or more selected checks that have been printed but not posted, in this illustrative embodiment. Reprint Checks action 224 includes determining whether check numbers originally assigned to the selected check or checks can be reused; reprinting the one or more selected checks, if it is determined that the check numbers originally assigned to the selected check or checks can be reused; and voiding the selected check or checks and printing replacement checks associated with Payment objects with which the selected check or checks were associated, if it is determined that the check numbers originally assigned to the selected check or checks cannot be reused, as described above with reference to FIG. 2. Printing the replacement check or checks includes assigning the replacement check or checks new check numbers. Still another option available from multi-option decision point 220 is Print Remittances action 222, for printing remittances as part of the check printing session.

In another, simplified embodiment, for example, check printing process 210 could include only session opening point 212, leading to Print Checks action 216, leading to decision point 220, which provides the options only of the Void Checks action 226, the Save Session action 228, and the Cancel Print action 230, while the latter two of these would proceed to decision point 232, from which endpoint 242 could be selected for confirming the session, posting the printed checks, and ending the check printing session. Other variations and embodiments are also included within the present invention.

Certain aspects of FIG. 2 are better understood in terms of a check printing process such as that described above with reference to FIG. 3, and as might for example be performed by executable application 40. For example, PrintSession object 14 of FIG. 2 may be used to open the process step 216 of FIG. 3, including by receiving Payment objects 28 and causing host computer 10 to retrieve a batch of check numbers from BankAccount object 24. BankAccount object 24 includes unique check numbers for each check drafted for BankAccount object 24, and includes information on the check numbers that have already been cleared or reserved or voided, and what check numbers are still available. Therefore, the BankAccount object 24 is able to supply a batch of unique, unused, and unreserved check numbers to PrintSession object 14 when PrintSession object 14 retrieves them from it. The process tracking fields 18 manage the check numbers used by PrintSession 14. One check number is assigned to each CheckToPrint object 20, which includes process tracking fields 22 to manage that particular check number for that CheckToPrint object 20. PrintSession object 14 uses a count of the CheckToPrint objects 20 that it contains to obtain the number of check numbers it will require for a given check printing session, to determine how many check numbers it retrieves from BankAccount object 24. It may be determined later, during a check printing process, that either more check numbers are needed for reprinting, or that some of the batch that was retrieved will not be needed after all. To address these possibilities, the host computer 10 is configured to retrieve a supplemental batch of check numbers from the BankAccount object 24 after the set of checks has already begun printing and the check printing process is underway, if the host computer 10 determines that PrintSession object 14 does not have enough check numbers at hand to finish printing the current set of checks; the host computer 10 is also configured to return check numbers to BankAccount object 24 that it determines it does not need, if a check printing session is confirmed and closed with some check numbers left over, that were not assigned to a posted check; and the host computer 10 is configured to void check numbers that were voided in the course of a check printing session, as described with reference to Void Checks step 226 of the process of FIG. 3.

Once PrintSession object 14 has retrieved those check numbers from BankAccount object 24, BankAccount object 24 places a reserve on those check numbers and will not assign them to another check printing process. For example, BankAccount object 24 may be accessible to a variety of other check printing processes besides that using a specific one of object model 8, but BankAccount object 24 will not disburse the reserved check numbers to any other check printing process, except for any check numbers, if any, that are returned to BankAccount object 24. PrintSession object 14 may use all the check numbers in the batch in a check printing session. PrintSession object 14 is also configured to cause host computer 10 to retrieve a supplemental batch of check numbers from BankAccount object 24 in the middle of a check printing session, if it is determined that additional check numbers are needed; and to return any unassigned check numbers to BankAccount object 24; and to void any check numbers with the BankAccount object 24.

PrintSession object 14 includes a variety of user-overrideable fields 16 and process tracking fields 18. The host computer 10 is configured to enter values into each of user-overrideable fields 16 and process tracking fields 18 for each PrintSession object 14. The user-overrideable fields 16 include, for example, the check date, the check format, the check stub format, the remittance format (if a remittance is to be used), a comment to be printed on the check stub, and sorting options. The host computer 10 may be configured to enter default values for any or all of these user-overrideable fields 16. For example, the host computer 10 may be configured to read the check date from an internal date/time properties object such as is typically loaded on a computer.

The host computer 10 is configured by the PrintSession object 14 to print the collection of CheckToPrint objects 20 such that the values entered to at least one of the data fields 16 are user-overrideable, such that a user-entered value may be entered to at least one of the data fields 16. The user could then override a default value for a given data field, for example, to enter a check format different from the default check format, for example. As a particular example, the default check format may be set on regular payroll checks, and the user may override that default and instead select an employee overtime check format.

Host computer 10 receives a set of Payment objects from a data source such as ERM database 44, HRM database 46, or user input via user interface 42, and associates each Payment object 28 with a CheckToPrint object 20 by a one-to-one (1:1) association in this embodiment, as depicted in FIG. 2. Each Payment object 28 includes information on an obligated payment to be made, such as a payroll payment to an employee or a purchase payment to a supplier, in one illustrative embodiment. ERM database 44 and HRM database 46 are representative data sources among many data sources to which host computer 10 has an available communicative connection. ERM database 44 and HRM database 46 may be included on a memory storage internal to host computer 10, in one embodiment. Alternately, ERM database 44 and HRM database 46 may be hosted on a separate computer or computers, communicatively connected to host computer 10 via a local area network (LAN), a wide area network (WAN), the Internet, or some other well-known communicative data connection. Host computer 10 retrieves a set of Payment objects 28 from data sources such as ERM database 44, HRM database 46, or user input via user interface 42, and iteratively creates CheckToPrint objects 20 associated with each transaction. Host computer 10 tracks the progress of the check printing session object 14, assigns a unique check number from among the batch of check numbers to each CheckToPrint object 20, and enters the assigned check number to a check number field of each CheckToPrint object 20. Host computer 10 also iteratively reads values from each Payment object 28 with which each respective CheckToPrint object 20 is associated, and enters the values from each Payment object 28, as received from the data source, to the data fields of the respective CheckToPrint object 20.

The transactions comprised in the ERM database are associated with a variety of enterprise resource management transaction types. These may include, for example, transactions for a payment to a supplier in exchange for goods supplied; a payment to a service provider, such as a lawyer, a consultant, or a copy shop, in exchange for services performed; a payment to a customer for a refund; or a payment to a bank on a banking product, such as a loan. Other types of ERM transactions are also possible. In this embodiment, the PrintChecksProcess object 12 configures the host computer 10 to print checks that are associated with ERM transactions when the respective data source is an ERM database. For example, the PrintChecksProcess object 12 may include configurations for check formats, check stub formats, check stub comments, or sorting options that are specific to various ERM transaction types.

As another example, the transactions comprised in the HRM database are associated with a variety of human resource management transaction types. These may include, for example, transactions associated with a regular payroll check; an overtime check; a commission check; or a bonus check. Other types of HRM transactions are also possible. In this embodiment, the PrintChecksProcess object 12 configures the host computer 10 to print checks that are associated with HRM transactions when the respective data source is an HRM database. For example, the PrintChecksProcess object 12 may include configurations for check formats, check stub formats, check stub comments, or sorting options that are specific to various HRM transaction types. In other words, in this embodiment, the PrintChecksProcess object 12 configures the host computer 10 both to print checks that are associated with ERM transactions when the respective data source is an ERM database, and to print checks that are associated with HRM transactions when the respective data source is an HRM database. The host computer 10 is configured according to both configurations as soon as it gains access to PrintChecksProcess object 12, and it is able to take advantage of one or the other configuration as one or the other data source becomes subject to receipt of Payment objects by host computer 10. This provides a great advantage over traditional check printing systems, which are often tailored either for human resource management, or for various enterprise resource management purposes, but which force an enterprise to use the two different check printing systems for the two different purposes.

In one illustrative embodiment, printing the set of checks, as in step 216, includes entering an indication in or to the respective data source that the set of Payment objects 28 has been received by the host computer 10 for the print session. This prevents a duplication-type error, such as is unfortunately possible under some traditional check printing systems. The feature of entering an indication in or to the respective data source is therefore of substantial advantage over certain prior art systems, according to this embodiment.

The PrintChecksProcess object 12 also configures host computer 10 to provide an option at user interface 42 for either reprinting or voiding a selected check, as depicted at decision point 220; to void the selected check, as depicted at step 226, if the option for voiding the selected check is entered; and to reprint the selected check, as depicted at step 224, if the option for reprinting the selected check is entered. As soon as a user has printed one check, the user is able to go back to review any check that has been printed in the print session, and decide whether to void or reprint that check, or set of checks. The user may then decide to select one or more checks at a time to void or reprint. The check numbers are voided too, unless they have not been used, in which case they may be released to be used by another process.

This provides another great advantage over traditional check printing systems, in which typically, an entire batch of checks must be reprinted together or voided together, and which do not allow reprinting or voiding individual checks within a transactional set or going back to review a check from among those already printed to evaluate whether it should be reprinted or voided. The host computer 10 is also configured in PrintChecksProcess object 12 so that if the print session has not yet been confirmed, the user also has the option to void all currently printed checks and cancel a current check printing session. Once a print session is confirmed, the checks are able to be posted and no additional check processing can be done.

PrintChecksProcess object 12 also configures host computer 10 to provide an option at the user interface 42 for saving the check printing session prior to confirming the check printing session, as depicted with step 228 in FIG. 3, in one illustrative embodiment. PrintChecksProcess object 12 also configures host computer 10 to save the check printing session, including saving at least a set of the values entered to the data fields of one or more checks from among the set of checks, if the option for saving the check printing session is selected. Host computer 10 is further configured to provide an option at the user interface 42 for reopening the saved check printing session, and to reopen the saved check printing session if the option for reopening the check printing session is entered. If the user enters the option for saving the check printing session, then all data on currently printed checks are saved, and may be accessed later, for the user to take up the check printing session again. The user may therefore decide after saving and reopening a check printing session whether to, for example, void or reprint all or some of the checks that had been printed, or that were in various stages of having values entered to their data fields without being printed. This sequence can be followed on FIG. 3 as proceeding from the Save Session set 228, to the decision point 232, and from there opting to reopen the saved session and proceed to multi-option decision point 220, wherefrom the Void Checks step 226 and the Reprint Checks step 224 are accessible.

In one embodiment, Save Session step 228 includes saving all aspects of the printed checks, the unprinted checks with some values entered in their data fields, check numbers that had not yet been used, and transactions for which associated checks had not yet printed, all of which may subsequently be reopened as if there had been no interruption. In another embodiment, for example, the host computer 10 may be configured to return the presently unused check numbers to the BankAccount object 24 when a check printing session is saved, or at some interval after the check printing session is saved, and to retrieve the check numbers or a new set of check numbers from the BankAccount object 24 when the saved session is reopened.

PrintChecksProcess object 12 also configures host computer 10 to provide an option at the user interface 42 for reprinting a selected check that has been printed, before the print session has been confirmed, as indicated with the Reprint Checks step 224, in one illustrative embodiment. A user may use this option to make a correction to a printed check, for example. In this case, the host computer 10 is configured to determine whether the check number originally assigned to the check selected for reprinting can be reused. If the host computer 10 determines that the check number originally assigned to the selected check can be reused, then it reprints the selected check. This reprinted check incorporates the new or modified values entered to the user-overrideable data fields of the check by the user during the process of selecting the check for reprinting, for example. If, on the other hand, the host computer 10 determines that the check number originally assigned to the selected check cannot be reused, then it voids the selected check, prints a replacement check associated with the Payment object with which the selected check was associated, assigns a new check number to the replacement check, and enters the assigned check number to the check number data field of the replacement check, rather than reprint the original check, in this illustrative embodiment. This process of voiding a check and assigning a second (or further) check number to a check covering the same Payment object may trigger an evaluation of the remaining check numbers and remaining Payment objects in the check printing session, to determine whether a supplemental batch of check numbers should be retrieved from the BankAccount object 24.

When the user is finished with a check printing session, she may confirm and close the check printing session, as indicated in FIG. 3 by proceeding from decision point 232 to endpoint 242. The printed checks are typically kept unposted until this time, in one embodiment, to allow the user the opportunity to go back and review the checks if needed right up until the end of the check printing session. In another illustrative embodiment, the entire check printing session is triggered by a scheduling function, and proceeds automatically through all steps up until the confirmation step, when host computer 10 then prompts a user through user interface 42. The host computer 10 is thereby configured by PrintChecksProcess object 12 to confirm the check printing session when so directed by a user, in this embodiment. In another embodiment or in another application, the host computer 10 may be configured to post a set of checks automatically. This might be the case, for example, with regular payroll checks that are printed and posted according to a set schedule. In such an application, the host computer may be configured to accept modifications of data fields prior to a certain cutoff time approaching the payees' payday, but automatically post the checks according to the then-current data fields after the scheduled cutoff time, to avoid delaying the issuance of the checks, for example. This may vary according to application or to embodiment, since a single host computer may be configured by PrintChecksProcess object 12 to confirm certain types of check printing processes only when so prompted by a user, and to confirm other types of check printing processes according to a predetermined scheduling function, for example.

Confirming the check printing process includes determining whether any of the check numbers from among the batch of check numbers were not assigned to a printed check, and returning these unassigned check numbers to the BankAccount object 24. Confirming the check printing process also includes determining whether any of the check numbers from among the batch of check numbers were voided, and voiding these check numbers with the BankAccount object 24. The host computer 10 is configured to make that determination and to return the unassigned check numbers to BankAccount object 24 accordingly. The host computer 10 is only configured to retain check numbers as part of a check printing process on a per session basis, and is not configured to retain check numbers between check printing sessions, in this embodiment. Confirming the check printing session also includes saving the PrintSession object 14 and the CheckToPrint objects 20 before closing the check printing session, in one illustrative embodiment. Incidentally, the computer 10 is also configured by PrintChecksProcess 12 to print a test form, for testing the alignment, layout, and printer settings.

Although the present invention has been described with reference to preferred embodiments, workers skilled in the art will recognize that changes may be made in form and detail without departing from the spirit and scope of the invention.

What is claimed is:

1. A computer-readable medium comprising computer-executable instructions which, when executed by a host computer, configure the host computer to perform a check printing process, wherein the host computer is configured to:
receive a set of payment objects from among one or more data sources, wherein each of the payment objects is associated with an account object from among one or more account objects;
create a print session object associated with a respective account object from among the one or more account objects;
retrieve a batch of check numbers from the respective account object;
print a set of checks associated with the set of payment objects, wherein printing the set of checks comprises entering values associated with the print session object and the payment objects to a plurality of data fields of each of the checks in the set, and assigning each of the checks in the set a check number from among the batch of check numbers;
provide an option at a user interface for confirming and closing the print session object; and
confirm and close the print session object if the option for confirming and closing the print session object is entered.

2. The computer-readable medium of claim 1, further comprising computer-executable instructions which, when executed by the host computer performing the check printing process, configure the host computer to:
provide options at the user interface for either reprinting or voiding any one or more selected checks from among the set of checks;
void the one or more selected checks if the option for voiding the one or more selected checks is entered; and
reprint the one or more selected checks if the option for reprinting the one or more selected checks is entered.

3. The computer-readable medium of claim 1, further comprising computer-executable instructions which, when executed by the host computer performing the check printing process, configure the host computer to:
provide an option at the user interface for saving the print session object prior to confirming the print session object, and an option for reopening the saved print session object;
save the print session object, including saving at least a set of the values entered to the data fields of one or more checks from among the set of checks, if the option for saving the check printing session is selected; and
reopen the saved print session object, if the option for reopening the print session object is entered.

4. The computer-readable medium of claim 1, wherein confirming the print session object comprises any of the check numbers from among the batch that were not assigned to a check being returned to the respective account object.

5. The computer-readable medium of claim 1, further comprising computer-executable instructions which, when executed by the host computer performing the check printing process, configure the host computer to:
determine whether check numbers originally assigned to the one or more selected checks can be reused;
provide the option for reprinting the one or more selected checks, if it is determined that the check numbers originally assigned to the one or more selected checks can be reused; and
provide the option for voiding the one or more selected checks and printing replacement checks associated with payment objects with which the one or more selected checks were associated, if it is determined that the check numbers originally assigned to the one or more selected checks cannot be reused, wherein printing the replacement checks comprises assigning the replacement checks new check numbers.

6. The computer-readable medium of claim 1, further comprising computer-executable instructions which, when executed by the host computer performing the check printing process, configure the host computer to retrieve a supplemental batch of check numbers from the account object, after the printing of the set of checks has begun.

7. The computer-readable medium of claim 1, further comprising computer-executable instructions which, when executed by the host computer performing the check printing process, configure the host computer to select the account object from among a plurality of account objects.

8. The computer-readable medium of claim 1, further comprising computer-executable instructions which, when executed by the host computer performing the check printing process, configure the host computer to print the set of checks such that at least one of the values entered to the plurality of data fields is user-overrideable, wherein a user-entered value may be entered to the at least one of the data fields.

9. The computer-readable medium of claim 1, wherein the one or more data sources comprise an enterprise resource management database comprising payment objects associated with enterprise resource management, and wherein configuring the host computer to print the set of checks comprises configuring the host computer to print checks that are associated with the enterprise resource management payment objects when the respective data source is the enterprise resource management database.

10. The computer-readable medium of claim 1, wherein the one or more data sources comprise a human resource management database comprising payment objects associated with human resource management, and wherein configuring the host computer to print the set of checks comprises configuring the host computer to print checks that are associated with the human resource management payment objects when the respective data source is the human resource management database.

11. The computer-readable medium of claim 1, wherein the one or more data sources comprise user input received through the user interface, and wherein configuring the host computer to print the set of checks comprises configuring the host computer to print checks comprising values from the user input entered to the data fields.

12. The computer-readable medium of claim 1, wherein printing the set of checks comprises providing an indication to the respective data source that the set of payment objects has been retrieved by the host computer for the print session.

13. The computer-readable medium of claim 1, wherein confirming the check printing session comprises providing an indication to the respective data source of whether each check, from among the set of checks associated with the set of payment objects, has been voided or printed.

14. The computer-readable medium of claim 1, further comprising computer-executable instructions which, when executed by the host computer performing the check printing process, configure the host computer to execute a scheduling function, whereby the computer is configured to receive a preselected time to perform a portion of the check printing process, whereby when the computer receives an indication that the preselected time has arrived, the computer automatically receives the set of payment objects; creates the print session object; retrieves the batch of check numbers; prints the set of checks; and provides the option at the user interface for confirming and closing the print session object.

15. A process for printing checks, comprising the steps of:
receiving a set of obligated payments to be made;
retrieving a batch of check numbers from an account object;
printing a set of checks, of which each check in a print session corresponds to one of the obligated payments and to the account object, wherein printing the set of checks comprises entering values to a plurality of data fields of each of the checks in the set of checks, and assigning each of the checks in the set of checks a check number from among the batch of check numbers;
providing a set of options at a user interface, including options for selecting any one or more checks from among the set of checks, an option for voiding the selected one or more checks, an option for reprinting the selected one or more checks, and an option for confirming the print session;
voiding the selected one or more checks if the option for voiding the selected one or more checks is entered;
reprinting the selected one or more checks if the option for reprinting the selected one or more checks is entered; and
confirming the print session if the option for confirming the print session is entered.

16. The process of claim 15, further comprising the steps of:
providing options at the user interface for saving the print session prior to confirming the print session, and for reopening the saved print session;
saving the print session, including saving at least a set of the values entered to the data fields of at least some of the checks, if the option for saving the print session is selected; and
reopening the saved print session, if the option for reopening the saved print session is entered.

17. The process of claim 15, further comprising the steps of:
providing an option at the user interface for reprinting a selected one or more checks that have been printed, before the print session has been confirmed;
determining whether check numbers originally assigned to the selected one or more checks can be reused;
reprinting the selected one or more checks, if it is determined that the check numbers originally assigned to the selected one or more checks can be reused; and
voiding the selected one or more checks and printing replacement checks for the selected one or more checks, if it is determined that the check numbers originally assigned to the selected one or more checks cannot be reused, wherein printing the replacement checks comprises assigning the replacement checks new check numbers.

18. A computing environment comprising an object model for a check printing process, the object model comprising:
a check printing process object constituting the root object of the object model;
one or more print session objects, wherein the check printing process object and the one or more print session objects are respectively in a parent-child relationship and a one-to-many relationship;
an account object associated with at least one of the one or more print session objects;
one or more check print objects, wherein at least one of the one or more print session objects and the one or more check print objects are respectively in a parent-child relationship and a one-to-many relationship; and
a payment object associated with at least one of the one or more check print objects.

19. The computing environment of claim 18, further comprising a computer-executable application which, when executed by a computer comprised in the computing environment, configures the computing environment to use the object model to perform the check printing process.

20. The computing environment of claim 19, further comprising:
an enterprise resource management database;
a human resource management database; and
a user interface;
wherein the object model is configured to receive payment objects from any of the enterprise resource management database, the human resource management database, and the user interface.
